(19) United States
(12) Patent Application Publication
(10) Pub. No.: US 2008/0181057 A1
(43) Pub. Date: Jul. 31, 2008

(54) PseudoRover GPS receiver

(75) Inventors: Donald G. Chamberlain, Calgary (CA); Zeljko Bacanek, Calgary (CA); Glenn Donald Hauer, Calgary (CA)

Correspondence Address: W. ALLEN MARCONTELL, P.O. BOX 800149, HOUSTON, TX, 77280-0149, US

(73) Assignee: ARAM Systems, Ltd., Calgary (CA)

(21) Appl. No.: 12/005,219

(22) Filed: Dec. 26, 2007

Related U.S. Application Data
(60) Provisional application No. 60/877,181, filed on Dec. 26, 2006.
(60) Provisional application No. 60/880,688, filed on Jan. 16, 2007.

(51) Int. Cl. G01V 1/22; G01S 1/00

(52) U.S. Cl. 367/76; 342/357.09

(57) ABSTRACT

A network distributed seismic data acquisition system comprises seismic receivers, connected to remote data acquisition modules, receiver lines, base line modules base lines, a central recording system and a seismic source event generation unit. A Global positioning system antenna is positioned at many or all seismic receiver take-out points. Each antenna is supported by minimal antenna signal processing circuitry for transmitting antenna reception to a base GPS receiver having full GPS signal processing capability for determining the distinctive global position of each antenna.

### CROSS-REFERENCE TO RELATED APPLICATIONS

The priority date benefit of Provisional Application No. 60/877,181 titled PseudoRover GPS Receiver filed Dec. 26, 2006 and of Provisional Application No. 60/880,688 titled PseudoRover GPS Receiver filed Jan. 16, 2007 is claimed for this application.

### STATEMENT REGARDING FEDERALLY SPONSORED RESEARCH OR DEVELOPMENT

Not Applicable.

### BACKGROUND OF THE INVENTION

1. Field of the Invention

The present invention relates to seismic survey equipment. In particular, the invention relates to seismic equipment assembly combinations and the logistics of seismic equipment deployment.

2. Description of the Related Art

Utilization of a land/transition zone seismic data acquisition system such as the ARAM ARIES system described by U.S. Pat. No. 6,977,867 entails the distribution of seismic sensor groups over a wide geographic area. A precisely located and timed seismic event such as an explosion or Vibroseis™ discharge releases shock (seismic) energy against and into the earth. Each sensor in a group detects the magnitude of such seismic energy received by the sensors and converts the detected energy magnitude to a corresponding electrical signal, either analog or digital. The sensor groups are connected to remote data acquisition modules (RAMs) which are joined to other RAMs and to other data processing/communication modules such as base line units (BLUs) or line tap units (LTUs) by communication signal carriers such as electrical cable, optical fibers or radio linkages that are further connected by appropriate signal carriers to a Central Recording Unit (CRU). As appearing herein, a sensor “group” may comprise one or more geophones, hydrophones or other pressure sensor type (vertical or multi-component) that remains in one position for a period of time, typically at least several days. Such a distributed data acquisition system is disclosed in U.S. Pat. No. 6,977,867.

After processing, sensor signal amplitude data is indicative of subsurface seismic conditions related to the geology and fluid content of the geologic formations. To facilitate correct processing of the acquired seismic data and enable optimum subsurface imaging, resolution analysis of the sensor data requires knowledge of the geographic position coordinates (X, Y and Z or longitude, latitude and altitude) for each sensor group and of the seismic event.

Conventional survey means comprise many available methods and may include the application of GPS, or other satellite system means such as GLONASS, in various forms to calculate position coordinates of sensor groups and seismic source points. A geometric plan of the seismic survey activity is formulated prior to field operations. In one conventional procedure, the planned locations of sensor groups are staked by surveyors. Implementation of real time GPS and combined GPS/inertial navigation systems in mobile units (called ‘Rovers’) may be done to assist the surveyors in placing (identifying and recording) the seismic source and sensor group locations. These portable GPS receiver systems are characterized as “Rover” systems due to the functional characteristic of transportability to a desired location for computation of its present position based on contemporaneously acquired data. The computed positions are used to facilitate the location of sources and sensor groups which may be staked for later deployment of equipment; or they may be used concurrently (without staking) to place the equipment, such as vibrator seismic sources, at their correct operational positions on the ground.

The term, GPS receiver, as defined according to industry practice and as used in this specification, is an integrated unit comprising an antenna, a data processor with a clock, a memory, input/output capability, a power supply and software which is capable of driving the data processing essential for acquiring GPS satellite signals utilizing the antenna and converting received GPS satellite signals to calculated positions and/or time of reception of the satellite signals and current time.

According to industry practice any device which is defined as a GPS receiver must be capable of receiving GPS satellite signals and processing them to compute position and/or time. A device comprising only an antenna and antenna signal-conditioning processor is not a GPS receiver but may be a component of a GPS receiver. If a GPS receiver can receive GPS satellite signals and process them to compute geographic position and/or time without receiving assistance from any other GPS receiver (such as a Master GPS receiver) it is a fully capable GPS receiver. If a GPS receiver receives assistance to perform these functions it is an assisted or slave GPS (aGPS) receiver.

The term GPS is defined in this document to encompass all present and all future satellite-based global positioning systems including the US NavStar Global Position System, the Russian GLONASS and the future European Galileo global positioning system.

One implementation process for GPS technology within land seismic acquisition systems requires an operative combination of GPS receivers with the RAMs and/or other distributed modules as components of the seismic data acquisition network. A Master GPS receiver in communication with the CRU may be used in combination with the aGPS receivers in the distributed modules. Differential GPS position analysis may be utilized wherein the Master GPS receiver is at a known location. Also, assisted GPS (aGPS) receivers may be implemented to receive tracking assistance information over the communication network from the Master GPS receiver. The aGPS receivers provide range data to the master for its processing and receive the resultant position calculations back from the master and can compute current time utilizing this location information. See U.S. Pat. No. 7,117,094 for a description of aGPS in a networked seismic data acquisition system.

All of the prior art disclosures and implementations of GPS positioning and synchronization for a distributed data acquisition network (whether for seismic or any other type of sensor data acquisition) call for a GPS receiver to be linked to its own individual GPS antenna and for the GPS antenna to be in physical proximity or incorporated together with other GPS receiver components in a tightly coupled manner.

The availability of a communication network connecting remote sensor groups within a data acquisition site and the fact that a sensor group may occupy a single physical position for an extended period of time (such as in one class of seismic data acquisition systems) provide an opportunity to utilize a single fully capable GPS receiver with a multitude of distributed GPS antennae to determine exact positions of the remote sensor arrays. Prior art has not recognized this opportunity and has required a GPS receiver at each GPS antenna, whether fully capable or, alternatively, requiring assistance from a Master GPS Receiver. Prior art has not recognized this opportunity and has required a GPS signal processor, i.e. receiver at each GPS antenna location, whether fully capable or, alternatively, requiring assistance from a Master GPS Receiver.

### SUMMARY OF THE INVENTION

The present invention is of a novel method and apparatus for acquiring GPS signals in a distributed sensor data acquisition system (such as a land/transition zone seismic data acquisition system) to better determine locations (including vertical and horizontal coordinates) and time of acquisition of sensor data. The disclosed invention is characterized by the implementation of one or more Base GPS Receivers (called PseudoRovers) which receive GPS signals from a multiplicity of remote GPS antennae which are static for an extended period of time (such as one or more days) as the GPS signals (and sensor data) are acquired. A PseudoRover processes selects portions of the remote GPS antennae data to determine individual antenna positions. A PseudoRover also processes GPS data from its local antenna. The time determinations from GPS signals may be used to synchronize a system Master Clock.

In this document, the term PseudoRover refers to a GPS receiver having full GPS signal (L1 and L2 frequency) processing capacity (fully capable). Distinctively, the PseudoRover may be supplied via a communication network with digital or analog signals from additional antennae. The additional antennae may be positioned over a wide area. The PseudoRover processes the signals from all of the antennae with which it is in communication

Selected GPS signal data received at the remote antenna stations may be communicated in analog or digital form to a PseudoRover via a network communication pathway connecting the sensor groups. Such a network communication pathway may consist of appropriate signal carriers passing through a series of RAM, BLU and TAP modules to the CRU and thence to the PseudoRover module. Alternatively, the antenna data may be recorded on removable media at the antenna location and physically moved to a PseudoRover or communicated to it by independent means. One or more PseudoRovers may be located within one communication network.

A PseudoRover may also be moved from one position in a communication network to another position in the network. The purpose of such a move may be to bring the PseudoRover into network proximity of a different group of antennae or simply for operational convenience.

### BRIEF DESCRIPTION OF THE DRAWINGS

The advantages and further aspects of the invention will be readily appreciated by those of ordinary skill in the art as the same becomes better understood by reference to the following detailed description when considered in conjunction with the accompanying drawings in which like reference characters designated like or similar elements throughout.

FIG. 1 schematically typifies a field layout of the invention.

FIG. 2 is a component assembly schematic of an antenna module according to a preferred embodiment of the invention.

FIG. 3 is a schematic for battery power supply to the antenna module for one embodiment of the invention.

FIG. 4 is a schematic for line power supply to the antenna module for one embodiment of the invention.

FIG. 5 is a schematic for power supply over communication cable to the antenna module for one embodiment of the invention.

FIG. 6 schematically represents a digital data packet and memory structure for time-stamped antenna data.

FIG. 7 represents a software algorithm for the invention to calculate position and time.

FIG. 8 is a schematic of a base GPS receiver module.

### DESCRIPTION OF THE PREFERRED EMBODIMENTS

Satellites of the NAVSTAR Global Positioning System orbit the earth at an altitude of approximately 20,000 km and transmit signals at a center frequency of 1575.42 MHz known as L1, and 1227.60 MHz known as L2. The signals are modulated such that nearly symmetric upper and lower sidebands are transmitted with the carrier completely suppressed. The L1 signal can be represented with the equation:

s_{L1}(t)=m(t)cos(2πf_{c}t+θ)+n(t)sin(2πf_{c}t+θ) eq. 1

where:
f_{c}=L1 frequency, and
m(t) and n(t) are pseudo-random functions with zero mean. Both functions are mutually orthogonal.
   Each of the satellites making up the NAVSTAR constellation of satellites transmit unique m(t) and n(t) functions which are all mutually orthogonal. The bandwidth of n(t) is exactly ten times m(t).

The L2 signal can be represented with the equation:

s_{L2}(t)=n(t)sin(2πf_{c}t+θ) eq. 2

where:

f_{c}=L2 frequency

m(t) is transmitted at the L1 frequency only, but n(t) is transmitted at both L1 and L2 frequencies. In the GPS literature, m(t) is known as the “Clear/Acquisition” code or C/A code and n(t) is known as the “Precision” code or P code. n(t) has exactly 10 times the bandwidth of the m(t) function.

The power spectral density of the m(t) modulating function is:

$$\frac{{sin}^{2} ( \frac{π f}{1.023 MHz} )}{{( \frac{π f}{1.023 MHz} )}^{2}} \qquad eq . 3$$

The power spectral density of the n(t) modulating function is:

$$\frac{{sin}^{2} ( \frac{π f}{10.23 MHz} )}{{( \frac{π f}{10.23 MHz} )}^{2}} \qquad eq . 4$$

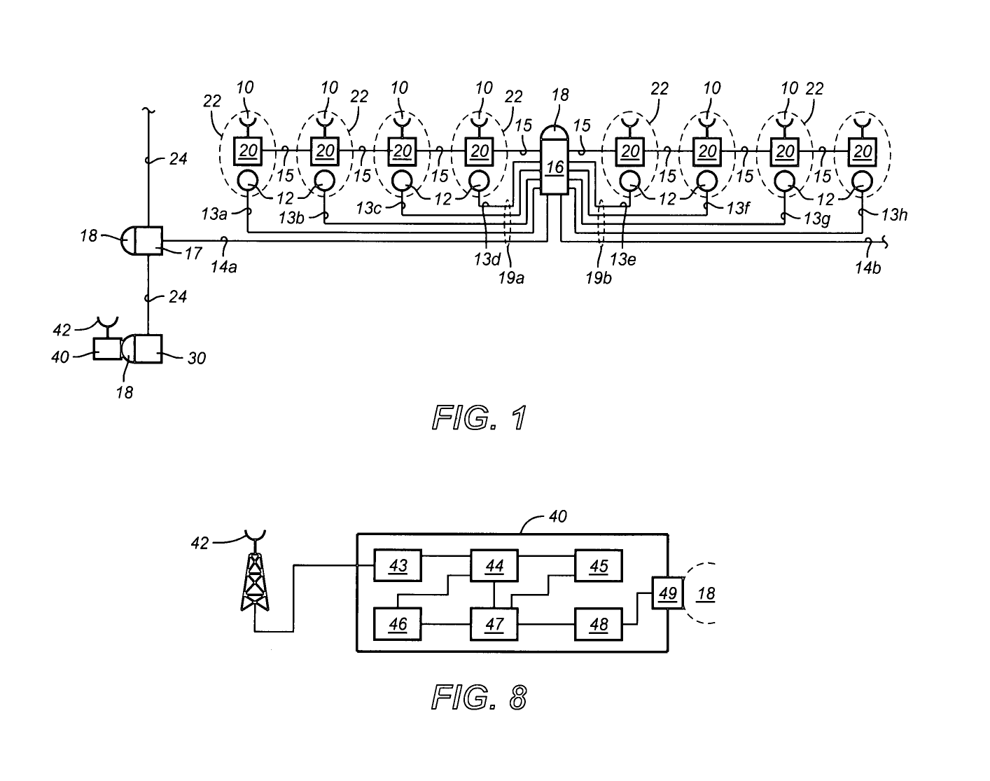

As represented by FIG. 1, one or more RAMs 16 are connected serially by sections of receiver line cable 19ₐ and 19_{b}. Typically, each section of receiver cable 19 comprises a data transmission conduit 14ₐ or 14_{b} and four seismic sensor signal carriers called “takeouts” 13_{a-d} and 13ₑ₋ₕ. Each takeout 13 respectively connects a seismic sensor group connection point 12 to a corresponding RAM 16. There may be, for example, more than three thousand groups 12 and takeouts 13 in a 3-dimensional seismic survey layout. One or more sensors (not shown separately) may be connected to a single takeout 13 at a respective group connection 12. The RAMs 16 are operatively linked to each other in a series and the series to a BLU 17 or to a LTU not shown by respective data transmission conduits 14ₐ and 14_{b}. Base line cable sections 24 (without sensor group takeouts) join successive BLUs and LTUs and ultimately connect to a CRU 30. Network telemetry is utilized to transmit commands and control information from the CRU 30 to the RAMs 16. Similarly, network telemetry is used to transmit acquired seismic data and other information to the CRU 30. Such other information may include GPS antenna signals.

In a preferred embodiment of the invention, GPS antennae 10 and respective antenna signal processing modules 20 are located within a close proximity zone 22 at or very near the location of each sensor group connection points 12. The present invention embodiment provides no direct connection or interaction between an antenna module 20 and a sensor group connection point 12, however.

Preferably, a GPS antenna 10 is semi-permanently affixed to the cable section 14 at the location of each takeout 12. When the cable section 14 is deployed for data acquisition, the GPS antenna may require manipulation by the layout technician to orient it in the optimum position for reception of typical GPS signals, normally vertical or near vertical.

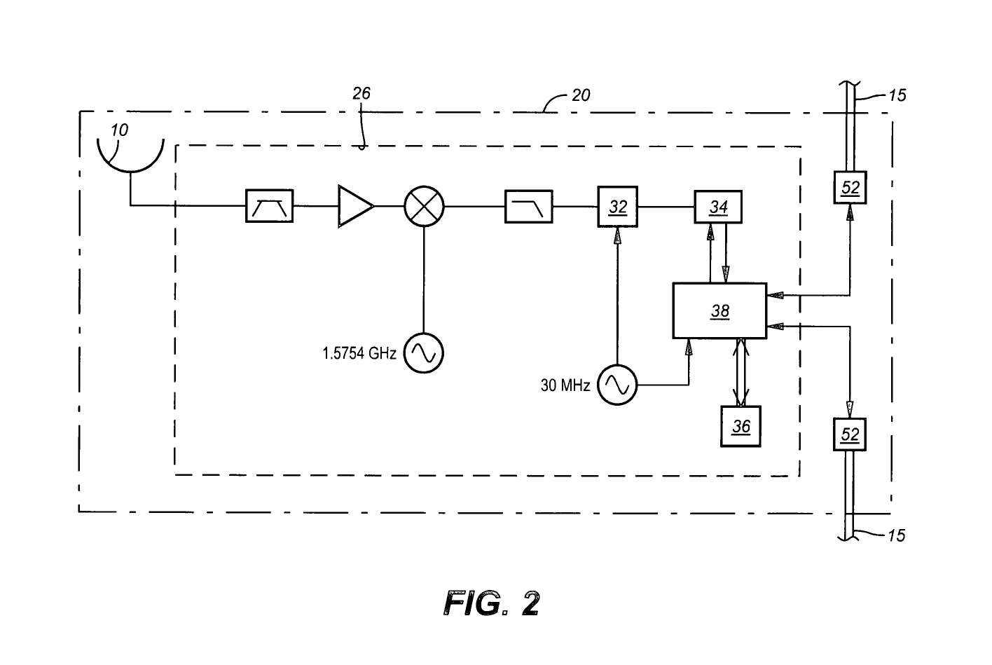

Each remote GPS antenna 10 is operatively connected to a signal conditioning processor 26. The antenna assembly together with the power supply and signal conditioning processor and ancillary incorporated items are collectively called the antenna module (AM) 20. See FIG. 2.

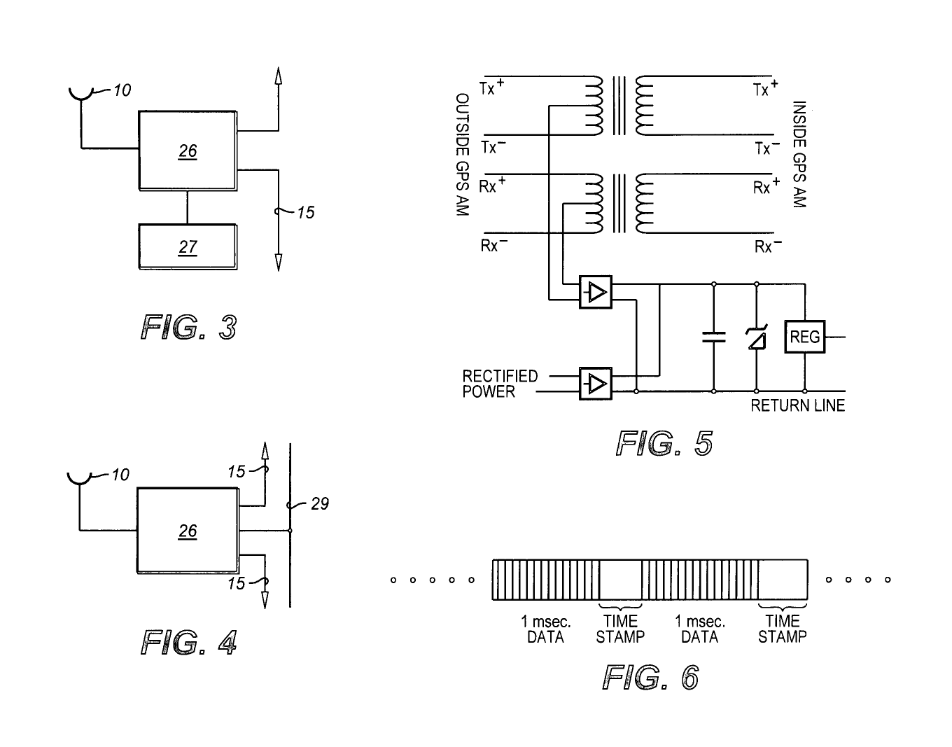

The signal conditioning processor receives power either from its own battery supply 27 (FIG. 3) or from conductors 29 supplied by a power source located elsewhere in the network, such as the nearest RAM 16 (FIG. 4).

The functionality of the signal conditioner 26 comprises reception of antenna-gathered GPS satellite signals and either transmitting them as analog or digital signals to the PseudoRover to which they are assigned. In the case of digital, transformation of the received signals in analog form from their original frequency band (1.57542 GHz) to the lowest available band (20 to 30 MHz approximately) and digitizing (A/D converter 32) these re-modulated signals in the lower band. Data compression means may be applied to the re-modulated signals. Transformation to a sign bit representation may be a possible means of data compression.

Signal-to-noise ratio enhancement processes may be applied in the signal conditioning processor 26. The sign bit transformation represents one potential means of signal-noise ratio enhancement, as it will mitigate the otherwise desultory effects of high amplitude noise bursts that temporarily obscure GPS signals.

The signal conditioning processor 26 also receives via the network a timing signal from the nearest local clock. Preferably, the nearest local clock is in the RAM that acquires the seismic data from the sensors connected at the takeout where the AM is located. The local clock is synchronized to the master clock at the CRU. The methods of U.S. Patent Application Publication US-2004-0105341-A1 are preferred for synchronizing the local clock to the master clock time. Preferred for stabilizing the rate of time measurement by the local module clocks is the method described by Timothy D. Hladik and Alan R. Phillips in their U.S. Provisional Patent Application No. 60/880,597 titled STABILIZING REMOTE CLOCKS IN A NETWORK.

After the GPS signals are processed by the signal conditioning processor within the AM 20, they, together with corresponding timing signals, may be stored in local memory 34 and recorded on removable media 36 by a controller 38. The removable media 36 is preferably a memory of very high storage capacity.

The signal conditioning processor 26 is capable of receiving and responding to commands originated at the CRU 30. Additionally, the signal conditioning processor 26 is capable of transmitting conditioned antenna data, timing data and other information, such as status information, via the network to the CRU 30.

Preferably the PseudoRover 40 controls the timing and duration of acquisition of GPS signals by each AM 20. Each AM may acquire GPS signals as directed by commands formulated by the PseudoRover 40 and implemented by the CRU 30. Commands may prescribe multiple time periods of varying duration for acquiring GPS signals.

Each AM 20 is independently controlled by addressed commands originated by the PseudoRover 40 (and implemented by the CRU). AMs operate independently of each other and may be activated simultaneously, sequentially, or any combination thereof by the PseudoRover acting through the CRU 30 via Rover interface 18. Because the multi-antenna GPS receiver of the present invention can determine positions of multiple points as normally accomplished by a mobile Rover—without physical movement of any equipment—it is called a PseudoRover. Moreover, the PseudoRover may interface at a RAM 16, BLU 17 or LTU as well as the CRU 30.

The PseudoRover 40 also acquires signals from a Base GPS antenna 42, which is located in proximity to it. See FIG. 8. This Base GPS Antenna 42 has a clear view of the sky and may be mounted on a tower to ensure this. The PseudoRover may process fully all GPS signals received via the Base GPS Antenna 42 as long as the supporting receiver is in operation and is selectively commanded to do so by the CRU 30.

As a full capacity GPS receiver, the PseudoRover 40 includes an antenna controller 43 for receipt of base antenna 42 signals and a communication processor 48 for receipt of AM 20 signals from the CRU 30 via interface connectors 18 and 49. See FIG. 8. Other constituents of the PseudoRover 40 comprise a signal conditioner 44, a signal processor 47, a memory 45 and a clock 46.

The Antenna Modules 20 are not fully capable receivers but are only dispersed elements of the PseudoRover. Neither are the Antenna Modules 20 slave receivers. The PseudoRover 40 has adequate processing capacity and is programmed to simultaneously process GPS signals from a multiplicity of AMs 20 while also processing signals from the Base GPS Antenna 42.

The communication network utilized by the AMs 20 is preferably one based on 100 BASE-TX Ethernet protocol. A four wire carrier may be contained in the cable 15 to support an implementation of this embodiment. TCP/IP is the preferred communication protocol to be used by the AMs 20.

One alternative embodiment of the invention may use digital or analog fiberoptic communication from each antenna location to another network location such as a RAM. If analog signals are transmitted by optical fiber, the signals could be digitized in the nearest RAM and then transmitted via the network to the PseudoRover 40. If digital signals are transmitted by optical fiber from the antenna location, the analog-to-digital conversion may take place at the antenna location.

Another embodiment of the invention may comprise a radio frequency communication link between the PseudoRover 40 and the AMs 20. In such an embodiment, the PseudoRover 40 may be mobile for reasons such as operational convenience or to obtain signal proximity with a selected group of AMs 20. Moreover, a radio frequency communications link may liberate the PseudoRover 40 physical unit from the physical unit of the CRU 30. As in the case of a wire or optical fiber signal carrier medium, a radio signal communication between the PseudoRover and the several AMs may be analog or digital.

Power, if supplied to the AMs from the RAM locations, may be carried by the Ethernet carrier wires using the Power Over Ethernet (POE) methodology represented schematically by FIG. 5.

The AMs 20 have a communications transceiver function as well as the functions previously described. They receive communications originated by the PseudoRover Unit 40, transmitted by the CRU 30 and relayed to them by intervening transceiver units. They relay such communications to the next more remote transceiver unit. They receive communications coming from the opposite direction (from a more remote transceiver unit and relay them onward toward the PseudoRover Unit. They also originate and transmit their own communications toward the PseudoRover Unit which ultimately receives them.

In terms of GPS antenna capability, in the preferred embodiment the AMs 20 are L1 capable only and are not designed with the additional complexity required for L1 plus L2. The PseudoRover 40 preferably has both L1 and L2 full capability.

Carrier phase utilization is not a requirement in the Preferred Embodiment although it could be incorporated for applications (possibly non-seismic) in which sub-meter or even sub-centimeter accuracy is desired.

PRN code from L1 GPS signals when effectively received over an extended period of time and processed by the PseudoRover 40 can provide accuracy to 30 cm which is considerably better than required for normal petroleum seismic data acquisition. Accuracy to within one meter is the objective of the invention in the seismic application of the preferred embodiment.

When addressed commands (formulated by the PseudoRover Unit and communicated to the CRU 30, for example, via a Rover interface 18 for implementation) require an AM 20 to transmit a selected time window of its data (FIG. 6) to the PseudoRover Unit, the AM 20 transmits the data via the Ethernet link to the next closest Ethernet transceiver unit 52, which transmits it onward toward the PseudoRover Unit. In a cable implementation of the preferred embodiment, the receiving transceiver unit, which may be another Antenna Unit 20 or a RAM 16, BLU 17 or LTU, further transmits the received data to the next closest unit along the network pathway toward the PseudoRover Unit 40. This process is repeated until the data is received by the PseudoRover Unit, possibly via the CRU 30 in the last stage of reception and transmission before the PseudoRover Unit is reached.

The data is then fully processed by the PseudoRover Unit 40 to determine the position of the AM 20. Referring to the Antenna Module 20 of FIG. 2, an L1 signal is first filtered with a SAW bandpass filter centered at the L1 frequency and amplified with a Low Noise Amplifier (LNA). FIG. 2 has a one stage RF to baseband demodulation step but it may be advantageous to add more demodulation steps to remove the carrier f_{c}. More stages can improve receiver sensitivity by increasing the ability to remove jamming signals.

The satellites are moving relative to the Antenna Module 20 which results in the carrier f_{c} being Doppler shifted by a maximum of approximately 4.5 Hz. The demodulation stage, or stages, should leave an allowance for the Doppler frequency when demodulating the modulating signals to baseband. The baseband signal is lowpass filtered and an analog-digital converter digitizes the analog signal. The digitized signal is stored in memory 34 by the controller 38. In addition, the controller 38 adds timing stamps to memory, approximately every millisecond. Refer to FIG. 6. The timing stamps are derived from a very accurate oscillator.

The controller 38 receives commands through two Ethernet transceivers 52 and transmits the data in memory through the Ethernet transceivers.

An external memory 36 interface is present which allows an external collection device to be connected to the Antenna Module 20 and the contents of memory in the Antenna Module to be written to the collection device.

The Antenna Module 20 can receive power from a few different methods. Refer to FIGS. 3, 4 and 5. The Antenna Module 20 may derive its power from batteries (FIG. 3), or a Power-over-Cable method (FIG. 5).

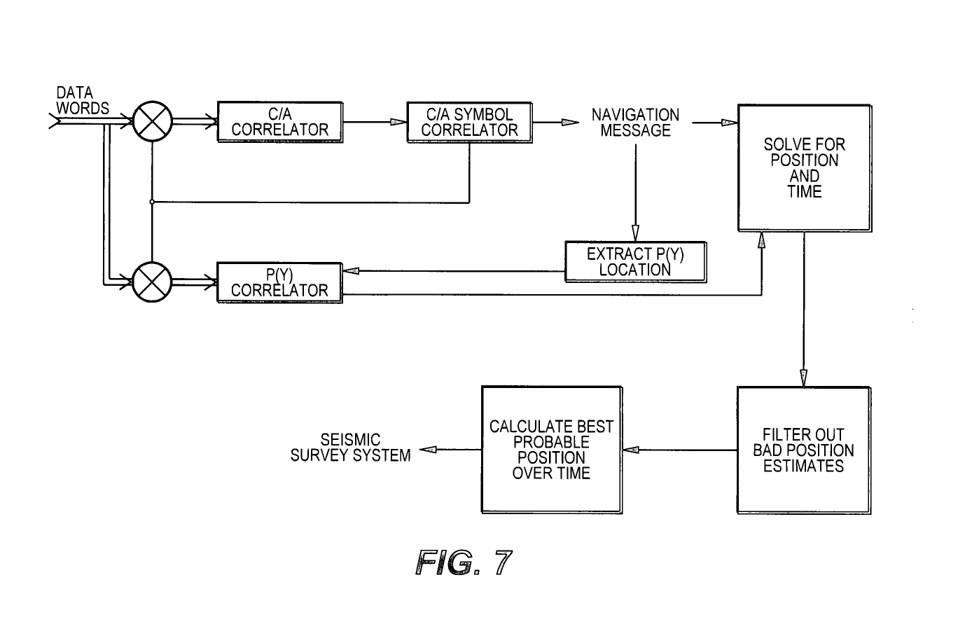

FIG. 7, illustrates an algorithm in the Pseudo-Rover to calculate position and time. The digital data collected in the Antenna Module is input into two tracking loops. The first loop correlates the received C/A sequence with the Pseudo Random/Number (PRN) sequence unique to each satellite. A strong correlation is tracked and the Doppler frequency is calculated and removed from the input data stream. The C/A phase is used to calculate Pseudo Range and is input in the Position and Time calculation. The Navigation Message is decoded from the PRN correlation and used to calculate Position and Time. The Navigation Message is used to calculate the current position in the P-Code sequence. The expected P-Code is correlated with the generated P-Code and the result is used as Pseudo Range data in the Position and Time calculation function. If the P-Code is encrypted, additional steps must be taken using the encrypted P-Code, commonly called Y-Code, in calculating Pseudo Range data.

Once the Pseudo Range data is calculated, it is used to generate a Position and time solution for the current epoch. During each epoch, the position and time may not exist because of lack of signal. The generated positions and times are filtered and a best probable position and time is calculated using methods such as least squares methods. The probable position is sent to the seismic survey system.

In this processing, the PseudoRover Unit may utilize pre-programmed position information such as the expected location of the AM based on the survey plan and a topographic model or other relevant position information. Utilization of such pre-planned information will optimize the determination of proper position coordinates for each AM upon reception of the GPS signal information from said AMs by the PseudoRover Unit.

The PseudoRover Unit uses the timing data concurrently acquired with the GPS signals by the AM to confirm time of GPS data acquisition and correctness of library procedures in GPS data identification.

The PseudoRover Unit may use the corresponding L2 data it has received and recorded to improve the positioning accuracy of the AM.

Multiple time epochs of GPS data from a single AM may be processed independently or combined in one processing execution to improve the positioning accuracy using calculation methods familiar to those experienced in GPS processing.

The PseudoRover evaluates the positioning results in terms of consistency and reliability using known methods and decides whether the position has been adequately determined. Adequacy of determination is based on survey accuracy goals input by the user to control the PseudoRover decision making as well as consistency of repeated observations.

If the position of the AM is deemed by the PseudoRover to be adequately determined it may command discontinuation of any further GPS data acquisition by that AM as long as it remains in the same position. However the communication transceiver functions of the AM will be continued so long as there are further remote AMs that have yet to be adequately positioned. If all further remote Antenna Units in that branch of the network have also been adequately positioned, the transceiver functions of that AM (and the further AMs) is also shut down to conserve power.

In terms of quality control of physical positioning of sensor groups, the PseudoRover is initially pre-programmed using information from a project plan that contains intended locations of all planned sensor groups and source points. The user prescribes quality control criteria that quantify the maximum deviation of actual location of each planned position to be tolerated. When the PseudoRover Unit calculates that a particular sensor group is more than the specified maximum deviation away from the planned position, it notifies the user immediately. The ‘Red Flag’ raised by the PseudoRover Unit may be acted upon or ignored by the user. If he desires he may halt survey operations to reposition the wrongly placed sensor group and its RAM, or he may continue with the survey operations with a documented change in the position of that RAM with respect to its original pre-planned position.

Having fully disclosed a preferred embodiment of our invention,

We claim:

1. A method of determining the respective positions of a plurality of remotely distributed locations in a seismic data acquisition system having a seismic data communication network, said method comprising the steps of:
positioning a GPS antenna module having minimal antenna signal processing capacity at each position in said seismic data acquisition system to be determined;
providing a base GPS receiver having a base antenna and full GPS signal processing and memory capacity;
receiving GPS satellite signals by said antenna modules;
processing said GPS satellite signals by said antenna modules for transmission to said base GPS receiver; and,
determining and recording the global position of each said antenna module by said base GPS receiver.

2. The method of claim 1 wherein said antenna modules receive said GPS satellite signals, perform signal conditioning processes on selected signals and transmit said selected and conditioned signals to said base GPS receiver over said seismic data communications network.

3. The method of claim 1 in which one or more of said antenna modules is proximate of a seismic sensor assembly.

4. The method of claim 1 in which one or more of said antenna modules is proximate of a seismic source assembly.

5. The method of claim 1 in which said seismic data communications network comprises at least one communication pathway provided by electrically conductive cable.

6. The method of claim 1 in which said seismic data communications network comprises at least one communications pathway provided by a fiber-optic conductor.

7. The method of claim 1 in which said seismic data communications network comprises at least one communications pathway provided by radio means.

8. The method of claim 1 in which said antenna modules receive global positioning system satellite signals with the aid of tracking assistance provided by said base GPS receiver over said seismic data communications network.

9. The method of claim 1 in which said base GPS receiver is provided with a base antenna, the global position of said base antenna being determined by said base GPS receiver.

10. The method of claim 9 in which said base GPS receiver utilizes said base antenna position and further received satellite signals to determine the correct calendar time.

11. The method of claim 1 in which said base GPS receiver and at least one of said antenna modules remains in a fixed position for an extended period of time.

12. The method of claim 9 in which the base antenna has a clear view of the sky.

13. The method of claim 1 in which at least one of said antenna modules has a partially obstructed view of the sky.

14. The method of claim 8 in which said base GPS receiver provides said tracking assistance information to said antenna modules, said tracking assistance including a list of currently potentially viewable satellites and their Doppler-shifted frequencies.

15. The method of claim 14 in which said antenna modules utilize said tracking assistance information to improve their reception of satellite signals.

16. The method of claim 1 in which said base GPS receiver determines that the position of one of said antenna modules has been adequately determined and causes cessation of acquisition and processing of GPS satellite signals by that antenna module as long as it remains at that location.

17. The method of claim 1 in which said base GPS receiver provides the computed position of an antenna module to that antenna module by utilizing said data communication network.

18. The method of claim 1 in which said transmission is by means of said seismic communications network.

19. The method of claim 1 in which said transmission is by means of physical media.

20. The method of claim 19 in which said physical media is a high capacity plug-in memory device.
